(19) United States
(12) Patent Application Publication
(10) Pub. No.: US 2019/0161359 A1
(43) Pub. Date: May 30, 2019

(54) METAL-SUBSTITUTED TITANIUM OXIDE, AND METHOD FOR PRODUCING METAL-SUBSTITUTED TITANIUM OXIDE SINTERED BODY

(71) Applicant: The University of Tokyo, Tokyo (JP)

(72) Inventors: Shin-ichi Ohkoshi, Tokyo (JP); Yuta Maeno, Tokyo (JP); Tomomichi Nasu, Tokyo (JP)

(21) Appl. No.: 16/086,956

(22) PCT Filed: Mar. 16, 2017
(86) PCT No.: PCT/JP2017/010769

§ 371 Date: Jan. 31, 2019

(30) Foreign Application Priority Data
Mar. 22, 2016 (JP) 2016-056848

(51) Int. Cl. C01G 23/04

(52) U.S. Cl. CPC C01G 23/04; C01P 2004/03; C01P 2002/72; H01F 1/0018; C01P 2002/88; C01P 2002/54; C01P 2006/40; C01P 2006/42

(57) ABSTRACT

Proposed are a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields, and a method for producing a metal-substituted titanium oxide sintered body. According to the present invention, it is possible to provide a metal-substituted titanium oxide having a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a crystal structure of a nonmagnetic semiconductor upon application of pressure or light, the metal-substituted titanium oxide having a composition in which some of Ti sites of Ti₃O₅ are substituted with any one of Mg, Mn, Al, V and Nb.

### TECHNICAL FIELD

The present invention relates to a metal-substituted titanium oxide, and a method for producing a metal-substituted titanium oxide sintered body.

### BACKGROUND ART

For example, Ti₂O₃, which is representative of oxides containing Ti³⁺ (hereinafter, referred to simply as titanium oxide), is a phase transition material having various interesting physical properties, and is known to undergo, for example, metal-insulator transition and paramagnetism-antiferromagnetism transition. In addition, Ti₂O₃ is known to have an infrared absorption, a thermoelectric effect, a magnetoelectric (ME) effect and the like, and also, has been found to have a magnetoresistance (MR) effect in recent years. These various physical properties have been studied only for bulk bodies (up to μm size) (see, for example, Non Patent Literature 1), and there are still many unclear points in its mechanism.

Meanwhile, in recent years, studies have also been conducted on nanoparticles (having a size of, for example, 100 nm or less) composed of Ti₃O₅ containing Ti³⁺, and a titanium oxide of Ti₃O₅ which does not undergo phase transition to β-Ti₃O₅ having the properties of a nonmagnetic semiconductor even at 460 [K] or lower and which maintains a paramagnetic metal state over the entire temperature range of 0 to 800 [K] is also known (see, for example, Patent Literature 1).

### CITATION LIST

### Non Patent Literature

Non Patent Literature 1: Hitoshi SATO, et al., JOURNAL OF THE PHYSICAL SOCIETY OF JAPAN Vol. 75, No. 5, May, 2006, pp.053702/1-4

### Patent Literature

Patent Literature 1: Japanese Patent Publication No. 5398025

### SUMMARY OF INVENTION

### Technical Problem

The titanium oxide of Ti₃O₅ as disclosed in Patent Literature 1 attracts attention because it has a non-conventional property of undergoing phase transition from a crystal structure in a paramagnetic metal state to a crystal structure as a nonmagnetic semiconductor upon application of pressure or light, and also, in the future, a titanium oxide having such a property may be applied in various technical fields. Thus, in recent years, it has been desired to develop a titanium oxide which has a novel composition, and is easily extensively applied in various fields.

Thus, the present invention has been made in view of the above-mentioned circumstances, and an object of the present invention is to propose a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields, and a method for producing a metal-substituted titanium oxide sintered body.

### Solution to Problem

For achieving the above-mentioned object, the metal-substituted titanium oxide according to the present invention has a composition in which some of Ti sites of Ti₃O₅ are substituted with any one of Mg, Mn, Al, V and Nb, and has a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a crystal structure of a nonmagnetic semiconductor upon application of pressure or light.

In addition, the method for producing a metal-substituted titanium oxide sintered body according to the present invention comprises: mixing a solution containing A (A is any one of Mg, Mn, Al, V and Nb) with a dispersion liquid in which TiO₂ particles are dispersed to generate particles composed of TiO₂ and A in the mixed solution; and sintering a precursor powder composed of particles extracted from the mixed solution under a hydrogen atmosphere to produce a metal-substituted titanium oxide sintered body composed of a metal-substituted titanium oxide in which some of Ti sites of Ti₃O₅ are substituted with A.

### Advantageous effects of Invention

According to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields, and a method for producing a metal-substituted titanium oxide sintered body.

### BRIEF DESCRIPTION OF DRAWINGS

FIG. 1 is a SEM image showing a configuration of a metal-substituted titanium oxide sintered body composed of a metal-substituted titanium oxide in which some of Ti sites of Ti₃O₅ are substituted with Mg.

FIG. 2A is a graph showing the result of measuring X-ray diffraction patterns of a plurality metal-substituted titanium oxides having different atomic ratios between Mg and Ti.

FIG. 2B is a graph showing the result of measuring an X-ray diffraction pattern of a metal-substituted titanium oxide containing Si as a standard substance.

FIG. 3 is a graph showing the result of measuring an X-ray diffraction pattern after application of pressure to a sample composed of a metal-substituted titanium oxide in which some of Ti sites of Ti₃O₅ are substituted with Mg.

FIG. 4 is a SEM image showing a configuration of a metal-substituted titanium oxide sintered body composed of a metal-substituted titanium oxide in which some of Ti sites of Ti₃O₅ are substituted with Mn.

FIG. 5A is a graph showing the result of measuring X-ray diffraction patterns of a plurality metal-substituted titanium oxides having different atomic ratios between Mn and Ti.

FIG. 5B is a graph showing the result of measuring an X-ray diffraction pattern of a metal-substituted titanium oxide containing Si as a standard substance.

FIG. 6 is a graph showing the result of measuring an X-ray diffraction pattern after application of pressure to a sample composed of a metal-substituted titanium oxide in which some of Ti sites of Ti₃O₅ are substituted with Mn.

FIG. 7A is a graph showing the result of measuring X-ray diffraction patterns of a plurality metal-substituted titanium oxides having different atomic ratios between Al and Ti.

FIG. 7B is a graph showing the result of measuring an X-ray diffraction pattern of a metal-substituted titanium oxide containing Si as a standard substance.

FIG. 8 is a graph showing the result of measuring an X-ray diffraction pattern after application of pressure to a sample composed of a metal-substituted titanium oxide in which some of Ti sites of Ti₃O₅ are substituted with Al.

FIG. 9 is a graph showing the result of measuring a magnetization by SQUID for a sample composed of a metal-substituted titanium oxide of MgₓTi₍₃₋ₓ₎O₅.

FIG. 10 is a graph showing the result of examining a phase transition temperature of a crystal structure by DSC for a sample composed of a metal-substituted titanium oxide of MgₓTi₍₃₋ₓ₎O₅.

FIG. 11 is a graph showing the result of examining a phase transition temperature of a crystal structure by DSC for a sample composed of a metal-substituted titanium oxide of MnₓTi₍₃₋ₓ₎O₅ .

FIG. 12 is a graph showing the result of examining a phase transition temperature of a crystal structure by DSC for a sample composed of a metal-substituted titanium oxide of AlₓTi₍₃₋ₓ₎O₅.

### DESCRIPTION OF EMBODIMENT

An embodiment of the present invention will be described in detail below with reference to the drawings.

(1) Outline of Metal-Substituted Titanium Oxide of Invention

A metal-substituted titanium oxide of the present invention has a λ-Ti₃O₅ type structure in which some of Ti sites of Ti₃O₅ disclosed in Japanese Patent No. 5398025 (hereinafter, referred to as λ-Ti₃O₅) are substituted with any one of Mg, Mn, Al, V and Nb, the metal-substituted titanium oxide being able to have a monoclinic crystal structure which is paramagnetic over the entire temperature range of 0 to 800 [K] and which maintains a paramagnetic metal state even at 460 [K] or lower (hereinafter, this crystal structure is referred to as a λ-phase) as in the case of λ-Ti₃O₅.

A bulk body composed of previously known Ti₃O₅ (hereinafter, referred to as a conventional crystal) is able to show an X-ray diffraction peak of β-Ti₃O₅ at a temperature of about 460 [K] or lower in X-ray diffraction (XRD) because it undergoes phase transition from a crystal structure of α-Ti₃O₅ in a paramagnetic metal state to a crystal structure of β-Ti₃O₅ of a nonmagnetic semiconductor at a temperature of about 460 [K] or lower. On the other hand, the λ-Ti₃O₅ disclosed in Japanese Patent No. 5398025 is able to have a monoclinic crystal structure (λ-phase) which does not undergo phase transition to a crystal structure of β-Ti₃O₅ of a nonmagnetic semiconductor even at a temperature of about 460 [K] or lower but maintains a paramagnetic metal state different from the crystal structure of the β-Ti₃O₅.

The metal-substituted titanium oxide according to the present invention in which some of Ti sites of λ-Ti₃O₅ are substituted with any one of Mg, Mn, Al, V and Nb is also able to have a monoclinic crystal structure (λ-phase) which does not undergo phase transition to a crystal structure of β-Ti₃O₅ of a nonmagnetic semiconductor even at a temperature of about 460 [K] or lower but maintains a paramagnetic metal state as in the case of λ-Ti₃O₅. That is, the metal-substituted titanium oxide of the present invention is able to have a monoclinic crystal structure (λ-phase) which maintains a paramagnetic metal state as in the case of λ-Ti₃O₅ at a temperature of about 460 [K] or lower because it does not show an X-ray diffraction peak of β-Ti₃O₅ of a nonmagnetic semiconductor in X-ray diffraction even at a temperature of about 460 [K] or lower, and shows an X-ray diffraction peak of λ-Ti₃O₅ different from β-Ti₃O₅ in position at which the X-ray diffraction peak is shown.

In addition, when the temperature is elevated from, for example, room temperature, the metal-substituted titanium oxide is able to start undergoing phase transition of the crystal structure at a temperature immediately above about 400 [K], show an X-ray diffraction peak of rhombic α-Ti₃O₅ of in a paramagnetic metal state in X-ray diffraction, and undergo phase transition to a rhombic crystal structure in a paramagnetic metal state at a temperature above about 500 [K]. Thus, the metal-substituted titanium oxide is able to maintain a paramagnetic metal state over the entire temperature range of 0 to 800 [K].

In addition, the metal-substituted titanium oxide is able to show an X-ray diffraction peak of β-Ti₃O₅ in X-ray diffraction, and undergo phase transition from a crystal structure in a paramagnetic metal state to a monoclinic crystal structure as a nonmagnetic semiconductor upon application of pressure or light at the time of having, for example, a monoclinic crystal structure in a paramagnetic metal state with which an X-ray diffraction peak of λ-Ti₃O₅ is shown in X-ray diffraction as in the case of λ-Ti₃O₅. In a metal-substituted titanium oxide having the same monoclinic crystal structure in a paramagnetic metal state as λ-Ti₃O₅ at about 460 [K] or lower, the crystal structure belongs to a space group C2/m, and in a metal-substituted titanium oxide which has undergone phase transition to the same rhombic crystal structure in a paramagnetic metal state as α-Ti₃O₅ when heated, the crystal structure belongs to a space group Cmcm. In addition, in a metal-substituted titanium oxide which has undergone phase transition to the same crystal structure of a nonmagnetic semiconductor as β-Ti₃O₅ upon application of pressure or light, the crystal structure belongs to a space group C2/m.

The metal-substituted titanium oxide has a crystal structure which undergoes phase transition to a crystal structure having a magnetization lower than a magnetization of a crystal structure in a paramagnetic metal state at 460 [K] or lower upon application of pressure or light at the time of having a crystal structure in a paramagnetic metal state.

Specifically, such a metal-substituted titanium oxide has, for example, a composition of AₓTi₍₃₋ₓ₎O₅ (A is any one of Mg, Mn, Al, V and Nb), and a structure in which some of Ti sites of λ-Ti₃O₅ are substituted with any one of Mg, Mn, Al, V and Nb. More specifically, it is preferable that x satisfies 0<x≤0.09 when A is Mg, x satisfies 0<x≤0.18 when A is any one of Mn, V and Nb, and x satisfies 0<x≤0.51 when A is Al.

Here, the metal-substituted titanium oxide according to the present invention can be produced as a metal-substituted titanium oxide sintered body. As a method for producing a metal-substituted titanium oxide sintered body composed of the metal-substituted titanium oxide according to the present invention, for example, a mixed solution is prepared by mixing a solution containing A consisting of one of Mg, Mn, Al, V and Nb with a dispersion liquid in which nanosized TiO₂ particles of 100 [nm] or less are dispersed, and titanium oxide particles are generated in the mixed solution (generation step). In the generation step, a precipitant such as aqueous ammonia is mixed with the mixed solution. In addition, here, the atomic ratio between A and Ti to be dissolved is adjusted to, for example, (A:Ti)=(more than 0:less than 100) to (10:90), preferably (A:Ti)=(more than 0:less than 100) to (6:94) when A is any one of Mg, Mn, V and Nb, and (A:Ti)=(more than 0:less than 100) to (10:90) when A is Al.

A precursor powder composed of titanium oxide particles is then extracted from the mixed solution, and the precursor powder is sintered under a hydrogen atmosphere (sintering step). The sintering step includes sintering, for example, at 900 to 1500[° C.] under a hydrogen atmosphere at 0.05 to 0.9 [L/min]. In this way, it is possible to produce a metal-substituted titanium oxide sintered body composed of a metal-substituted titanium oxide in which some of Ti sites of Ti₃O₅ are substituted with any one of Mg, Mn, Al, V and Nb. The sintering time is preferably 1 hour or more. Hereinafter, the metal-substituted titanium oxide when A is Mg, A is Mn, A is Al, A is V and A is Nb will be described in order.

(2) Metal-Substituted Titanium Oxide in Which Some of Ti Sites of Ti₃O₅ are Substituted with Mg

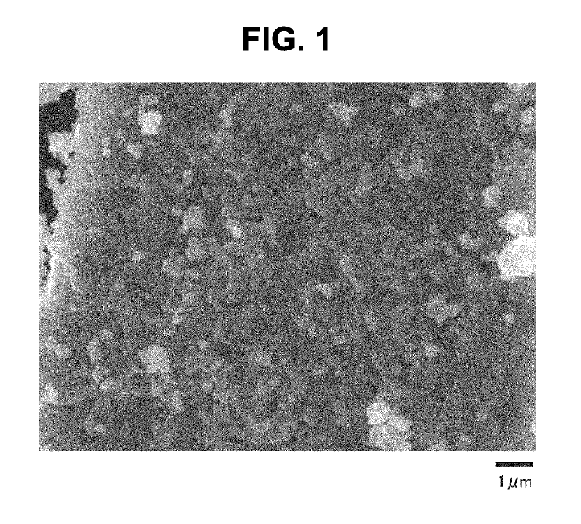

FIG. 1 is a SEM (Scanning Electron Microscope) image of a metal-substituted titanium oxide sintered body composed of a metal-substituted titanium oxide in which some of Ti sites of Ti₃O₅ are substituted with Mg, and the metal-substituted titanium oxide sintered body has a size of, for example, about 200 to 650 [nm] in terms of a particle diameter, and a porous structure in which a plurality of fine particles are bonded to make the surface uneven. The particle diameter is measured by analysis of the SEM image.

Here, on the surface of the metal-substituted titanium oxide sintered body, a plurality of irregularly shaped and sized particles in the form of a sphere, a hemisphere, a semiellipse, a spherical crown or a droplet are closely shaped, and in addition to, convexly particles, and irregularly sized recesses which are unevenly complicated at the inner part are formed, so that a flake-like uneven shape, or a coral reef-like uneven shape is formed.

The metal-substituted titanium oxide that forms a metal-substituted titanium oxide sintered body has a composition in which two Ti³⁺ in λ-Ti₃O₅ having a composition of Ti³⁺₂Ti⁴⁺O₅ are substituted with Mg²⁺ and Ti⁴⁺, e.g. a composition of MgₓTi₍₃₋ₓ₎O₅ (0<x≤0.09). The metal-substituted titanium oxide of MgₓTi₍₃₋ₓ₎O₅ is able to have a monoclinic crystal structure maintaining a paramagnetic metal state because it shows an X-ray diffraction peak of λ-Ti₃O₅ in X-ray diffraction at a temperature of 460 [K] or lower as in the case of λ-Ti₃O₅.

Thus, the metal-substituted titanium oxide of MgₓTi₍₃₋ₓ₎O₅ is able to maintain a paramagnetic metal state over the entire temperature range of 0 to 800 [K] because it does not undergo phase transition to a crystal structure of β-Ti₃O₅ of a nonmagnetic semiconductor at a temperature of 460 [K] or lower. In addition, the metal-substituted titanium oxide of MgₓTi₍₃₋ₓ₎O₅ is able to show an X-ray diffraction peak of β-Ti₃O₅ in X-ray diffraction, and undergo phase transition from a crystal structure in a paramagnetic metal state to a monoclinic crystal structure as a nonmagnetic semiconductor upon application of pressure or light at the time of having a monoclinic crystal structure in a paramagnetic metal state with which an X-ray diffraction peak of λ-Ti₃O₅ is shown in X-ray diffraction.

Since the metal-substituted titanium oxide sintered body composed of a metal-substituted titanium oxide of MgₓTi₍₃₋ₓ₎O₅ can be produced in accordance with the production method described above in “(1) Outline of metal-substituted titanium oxide of invention” including sintering conditions in production, the description thereof is omitted here in order to avoid repetition in description.

(2-1) Verification Test

Next, the metal-substituted titanium oxide of MgₓTi₍₃₋ₓ₎O₅ was produced in accordance with the production method described above in “(1) Outline of metal-substituted titanium oxide of invention”, and the X-ray diffraction pattern of the metal-substituted titanium oxide was examined. Specifically, a sol-like dispersion liquid (trade name “STS-01” manufactured by Ishihara Sangyo Kaisha, Ltd.) was prepared in which TiO₂ particles having an X-ray particle diameter of about 7 [nm] are mixed in an aqueous nitric acid solution at a concentration of 30 [wt %].

Magnesium acetate (Mg(CH₃COO)₂.4H₂O) was then dissolved in the dispersion liquid, the resulting solution was stirred to homogenize the solution, and a precipitant (aqueous ammonia) was then mixed therewith to generate a mixed solution. Here, the amount of the magnesium acetate was adjusted to set the atomic ratio between Mg and Ti in the mixed solution to Mg:Ti=2:98, Mg:Ti=4:96, Mg:Ti=6:94, Mg:Ti=8:92 and Mg:Ti=10:90.

Each mixed solution was then centrifuged to separate particles composed of titanium oxide (TiO₂) and magnesium hydroxide (Mg(OH)₂) from the mixed solution, and these particles were then washed and dried, whereby particles composed of titanium oxide and magnesium hydroxide were extracted from the mixed solution to obtain a precursor powder.

The precursor powder as an aggregate of particles composed of titanium oxide and magnesium hydroxide was then sintered at a predetermined temperature (1100° C.) for a predetermined time (about 5 hours) under a hydrogen atmosphere (0.7 L/min). Through the sintering treatment, the particles composed of titanium oxide and magnesium hydroxide were subjected to a reduction reaction with hydrogen, so that Ti⁴⁺ was reduced to generate a metal-substituted titanium oxide sintered body composed of a metal-substituted titanium oxide in which a part of Ti₃O₅ being an oxide containing Ti³⁺ is substituted with Mg.

In addition, separately, a titanium oxide sintered body composed of Ti₃O₅ as disclosed in Japanese Patent No. 5398025 was generated as a comparative example using a Mg-free dispersion liquid with Mg:Ti=0:100 (atomic number ratio) separately from the above-mentioned mixed solutions. Specifically, a sol-like dispersion liquid (trade name “STS-01” manufactured by Ishihara Sangyo Kaisha, Ltd.) in which TiO₂ particles having an X-ray particle diameter of about 7 [nm] are mixed in an aqueous nitric acid solution at a concentration of 30 [wt %] was centrifuged to obtain particles composed of titanium oxide (TiO₂), and these particles were washed and dried, and the obtained precursor powder was then sintered under the same sintering conditions as described above. Through the sintering treatment, the particles composed of titanium oxide were subjected to a reduction reaction with hydrogen, so that Ti⁴⁺ was reduced to generate a titanium oxide sintered body composed of Ti₃O₅ being an oxide containing Ti³⁺. This is λ-Ti₃O₅ in Japanese Patent No. 5398025 in which a Ti site is not substituted with Mg.

For the thus-produced powders composed of metal-substituted titanium oxide sintered bodies (hereinafter, referred to simply as sintered powders) having different atomic ratios between Mg and Ti, X-ray fluorescence (XRF) analysis was performed, and it was possible to confirm that there were no impurity elements. In addition, as a result of X-ray fluorescence analysis, it was possible to confirm that the metal-substituted titanium oxide sintered body produced from a mixed solution adjusted to a Mg:Ti ratio of 2:98 in the production process had a Mg:Ti ratio of 1:99, and a composition of MgₓTi₍₃₋ₓ₎O₅ (x=0.03).

In addition, as a result of X-ray fluorescence analysis, it was possible to confirm that the metal-substituted titanium oxide sintered body produced from a mixed solution adjusted to a Mg:Ti ratio of 4:96 in the production process had a Mg:Ti ratio of 2:98, and a composition of MgₓTi₍₃₋ₓ₎O₅ (x=0.07), and further, as a result of X-ray fluorescence analysis, it was possible to confirm that the metal-substituted titanium oxide sintered body produced from a mixed solution adjusted to a Mg:Ti ratio of 6:94 in the production process had a Mg:Ti ratio of 3:97, and a composition of MgₓTi₍₃₋ₓ₎O₅ (x=0.09).

As a result of X-ray fluorescence analysis, it was possible to confirm that the metal-substituted titanium oxide sintered body produced from a mixed solution adjusted to a Mg:Ti ratio of 8:92 in the production process had a Mg:Ti ratio of 4:96, and a composition of MgₓTi₍₃₋ₓ₎O₅ (x=0.12), and further, as a result of X-ray fluorescence analysis, it was possible to confirm that the metal-substituted titanium oxide sintered body produced from a mixed solution adjusted to a Mg:Ti ratio of 10:90 in the production process had a Mg:Ti ratio of 5:95, and a composition of MgₓTi₍₃₋ₓ₎O₅ (x=0.14). Hereinafter, each sintered powder will be distinctively described with the value of x.

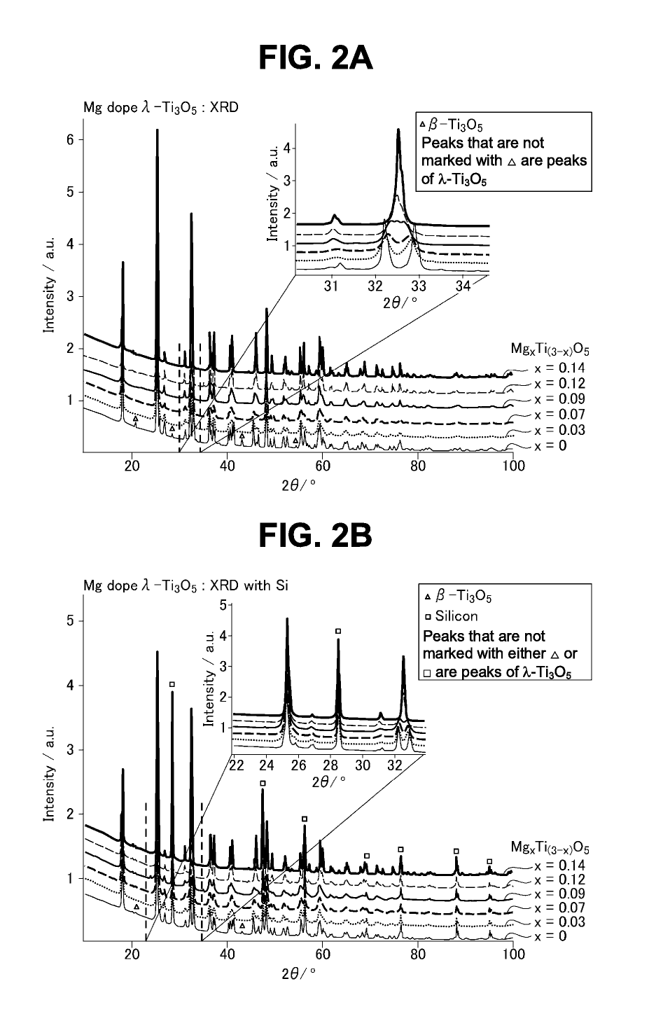

Next, the X-ray diffraction pattern was measured at room temperature for each of the sintered powders and a powder composed of a titanium oxide sintered body of Ti₃O₅ (hereinafter, referred to simply as a Ti₃O₅ sintered powder), and results shown in FIG. 2A were obtained. FIG. 2A shows a diffraction angle on the abscissa, and an X-ray diffraction intensity on the ordinate, where the X-ray diffraction pattern of Ti₃O₅ disclosed in Japanese Patent No. 5398025 in which a Ti site is not substituted with Mg is indicated by “x=0”.

As shown in FIG. 2A, it was possible to confirm that the Ti₃O₅ sintered powder showed an X-ray diffraction peak at a position different from the positions of the X-ray diffraction peak of α-Ti₃O₅ and the X-ray diffraction peak of β-Ti₃O₅. Here, the Ti₃O₅ sintered powder which shows an X-ray diffraction peak at a position different from the positions of the X-ray diffraction peak of α-Ti₃O₅ and the X-ray diffraction peak of β-Ti₃O₅ is defined as having a crystal structure of λ-Ti₃O₅. In addition, the Ti₃O₅ sintered powder having a crystal structure of λ-Ti₃O₅ is confirmed to have maintain a crystal structure in a paramagnetic metal state even at a temperature of 460 [K] or lower, and maintain a paramagnetic metal state over the entire temperature range of 0 to 800 [K] in Japanese Patent No. 5398025.

Next, the X-ray diffraction patterns of the sintered powders were compared with the X-ray diffraction pattern of the Ti₃O₅ sintered powder. The X-ray diffraction pattern of the Ti₃O₅ sintered powder (x=0) showed two X-ray diffraction peaks, for example, at a diffraction angle around 32 degrees to 33 degrees. On the other hand, it was possible to confirm that the X-ray diffraction pattern of the sintered powder wherein x=0.03 and the X-ray diffraction pattern of the sintered powder wherein x=0.07 showed two X-ray diffraction peaks similarly at a diffraction angle around 32 degrees to 33 degrees although the X-ray diffraction peaks had a lower height as compared to λ-Ti₃O₅.

In addition, it was possible to confirm that the X-ray diffraction pattern of the sintered powder wherein x=0.09 slightly showed two trapezoidal peaks similarly at a diffraction angle around 32 degrees to 33 degrees although the peaks did not have a valley as clearly observable as that in the case of the Ti₃O₅ sintered powder. Thus, it was possible to confirm that the sintered powders wherein x=0.03, x=0.07 and x=0.09 had the same crystal structure as the crystal structure of λ-Ti₃O₅ in the Ti₃O₅ sintered powder. In addition, it was possible to confirm that the sintered powders wherein x=0.03, x=0.07 and x=0.09 had none of crystal structures of α-Ti₃O₅ and β-Ti₃O₅ because they did not show an X-ray diffraction peak of α-Ti₃O₅ and an X-ray diffraction peak of β-Ti₃O₅.

On the other hand, it was possible to confirm that the X-ray diffraction pattern of the sintered powder wherein x=0.12 as a comparative example, and the X-ray diffraction pattern of the sintered powder wherein x=0.14 also as a comparative example showed one sharp X-ray diffraction peak similarly at a diffraction angle around 32 degrees to 33 degrees unlike the Ti₃O₅ sintered powder. Thus, it was possible to confirm that the sintered powders wherein x=0.12 and x=0.14 were different in crystal structure from the Ti₃O₅ sintered powder, and did not have a crystal structure of λ-Ti₃O₅ as in the Ti₃O₅ sintered powder.

Next, for examining an X-ray diffraction peak shift caused by an error in an X-ray diffraction apparatus, etc., Si as a standard substance for giving a standard of an X-ray diffraction peak was physically mixed with the sintered powders wherein x=0.03, x=0.07, x=0.09, x=0.12 and x=0.14 and the Ti₃O₅ sintered powder wherein x=0 described above.

For each of the thus-produced powders composed of metal-substituted titanium oxide sintered bodies having different atomic ratios between Mg and Ti (sintered powders) and powder composed of a titanium oxide sintered body of Ti₃O₅ (Ti₃O₅ sintered powder), the X-ray diffraction pattern was measured at room temperature as described above, and results shown in FIG. 2B were obtained.

From FIG. 2B, it was also possible to confirm from the positions of X-ray diffraction peaks that the sintered powders wherein x=0.03, x=0.07 and x=0.09 had a crystal structure similar to that of λ-Ti₃O₅ in the sintered powder. It was possible to confirm that particularly, the sintered powder wherein x=0.09 showed two X-ray diffraction peaks sharper than those in FIG. 2A at a diffraction angle around 32 degrees to 33 degrees although the X-ray diffraction peaks had a lower height as compared to λ-Ti₃O₅. Thus, it was possible to confirm that the sintered powders wherein x=0.03, x=0.07 and x=0.09 maintained a crystal structure in a paramagnetic metal state even at a temperature of 460 [K] or lower because they had the same crystal structure of λ-Ti₃O₅ in a paramagnetic metal state as that of the Ti₃O₅ sintered powder rather than a crystal structure of β-Ti₃O₅ of a nonmagnetic semiconductor.

Thus, it was possible to confirm that the metal-substituted titanium oxide of MgₓTi₍₃₋ₓ₎O₅ (0<x≤0.09) was able to maintain a paramagnetic metal state because it did not show an X-ray diffraction peak of β-Ti₃O₅ even at 460 [K] or lower, and showed an X-ray diffraction peak of λ-Ti₃O₅. The metal-substituted titanium oxide of MgₓTi₍₃₋ₓ₎O₅ (0<x≤0.09) is able to maintain a paramagnetic metal state over the entire temperature range of 0 to 800 [K].

Next, for the sintered powders having different atomic ratios between Mg and Ti and the Ti₃O₅ sintered powder, the lattice constant was examined by performing Rietveld analysis from the X-ray diffraction pattern shown in FIG. 2A, and the result showed that for β[°], there was also a negative correlation with respect to the content of Mg at x=0.03 to 0.14. In the sintered powders wherein x=0.03, x=0.07 and x=0.09, the crystal structure belongs to a space group C2/m.

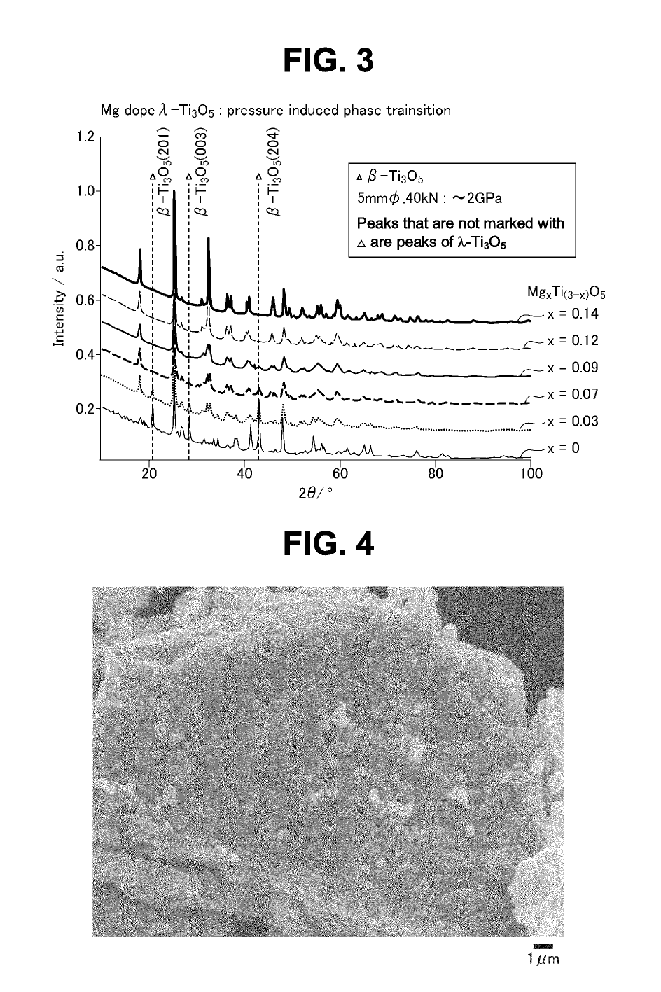

Next, a pressure of 40 [kN] (up to 2 [GPa]) was applied to the sintered powders having different atomic ratios between Mg and Ti and the Ti₃O₅ sintered powder in a tablet molding machine for IR, which is capable of molding pellets of 5 mmφ, and the X-ray diffraction pattern was examined after release of pressure. Consequently, results shown in FIG. 3 were obtained.

It was possible to confirm that the sintered powders wherein x=0.03, x=0.07 and x=0.09 had the same crystal structure as that of Ti₃O₅ sintered powder because they showed a characteristic X-ray diffraction peak at the same position as in the Ti₃O₅ sintered powder after application of pressure as shown in FIG. 3. Here, the same Ti₃O₅ sintered powder as in Japanese Patent No. 5398025 showed X-ray diffraction peaks at diffraction angles of 21 degrees, 28 degrees and 43 degrees, respectively, when pressure was applied as shown in FIG. 3. These X-ray diffraction peaks corresponded, respectively, to the (201) plane, the (003) plane and the (204) plane of β-Ti₃O₅. Thus, it was possible to confirm that the Ti₃O₅ sintered powder showed an X-ray diffraction peak of β-Ti₃O₅, and underwent phase transition from a crystal structure of λ-Ti₃O₅ to a crystal structure of β-Ti₃O₅.

It was possible to confirm that when pressure was applied, the sintered powders wherein x=0.03 and x=0.07 showed an X-ray diffraction peak of β-Ti₃O₅, and underwent phase transition from a crystal structure of λ-Ti₃O₅ to a crystal structure of β-Ti₃O₅ as in the case of the Ti₃O₅ sintered powder. In addition, for the sintered powder wherein x=0.09, it was possible to confirm that an X-ray diffraction peak of β-Ti₃O₅ was shown, so that the crystal structure was confirmed to undergo phase transition. Thus, it was possible to confirm that the sintered powders wherein x=0.03, x=0.07 and x=0.09 had a crystal structure which undergoes phase transition from a crystal structure of λ-Ti₃O₅ in a paramagnetic metal state to a nonmagnetic semiconductor upon application of pressure.

Next, pellets were prepared using the sintered powder wherein x=0.07, water glass was poured to the pellets to prepare a sample to be irradiated with light, the sample was then irradiated with laser light, and the state of the surface of the sample was examined. The sample was irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored, indicating that the crystal structure underwent phase transition.

In addition, the discolored portion of the sample was further irradiated with 532 [nm] pulse laser light (Nd³⁺ YAG laser) of 1.7×10⁻⁶ mJ m⁻² pulse⁻¹, a portion subjected to a predetermined light intensity by the pulse laser light was examined, and it was possible to confirm that the portion irradiated with the pulse laser light was slightly discolored, indicating that the crystal structure underwent phase transition.

The irradiated portion of the sample was further irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored again, indicating that the crystal structure underwent phase transition. Thus, it was possible to confirm that in the sintered powder wherein x=0.07, the crystal structure also underwent phase transition when irradiated with light.

(2-2) Action and Effects

With the above configuration, in the present invention, a mixed solution containing TiO₂ particles and Mg in a predetermined amount is prepared, particles composed of TiO₂ and Mg are generated in the mixed solution, and a precursor powder composed of particles extracted from the mixed solution is sintered under a hydrogen atmosphere, whereby it is possible to produce a metal-substituted titanium oxide sintered body composed of a metal-substituted titanium oxide in which some of Ti sites of Ti₃O₅ are substituted with Mg.

The metal-substituted titanium oxide that forms the metal-substituted titanium oxide sintered body is able to have a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a nonmagnetic semiconductor upon application of pressure or light. Thus, according to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields.

(3) Metal-Substituted Titanium Oxide in Which Some of Ti Sites of Ti₃O₅ are Substituted with Mn

FIG. 4 is a SEM image of a metal-substituted titanium oxide sintered body 1 composed of a metal-substituted titanium oxide in which some of Ti sites of Ti₃O₅ are substituted with Mn, and the metal-substituted titanium oxide sintered body has a size of, for example, about 250 to 1100 [nm] in terms of a particle diameter, and a porous structure in which a plurality of fine particles are bonded to make the surface uneven. The particle diameter is measured by analysis of the SEM image.

Here, on the surface of the metal-substituted titanium oxide sintered body, a plurality of irregularly shaped and sized particles in the form of a sphere, a hemisphere, a semiellipse, a spherical crown or a droplet are closely shaped, and in addition to, convexly particles, and irregularly sized recesses which are unevenly complicated at the inner part are formed, so that a flake-like uneven shape, or a coral reef-like uneven shape is formed.

The metal-substituted titanium oxide that forms a metal-substituted titanium oxide sintered body has a composition in which two Ti³⁺ in λ-Ti₃O₅ having a composition of Ti³⁺₂Ti⁴⁺O₅ are substituted with Mn²⁺ and Ti⁴⁺, e.g. a composition of MnₓTi₍₃₋ₓ₎O₅ (0<x≤0.18). The metal-substituted titanium oxide of MnₓTi₍₃₋ₓ₎O₅ is able to have a monoclinic crystal structure maintaining a paramagnetic metal state because it shows an X-ray diffraction peak of λ-Ti₃O₅ in X-ray diffraction at a temperature of 460 [K] or lower as in the case of λ-Ti₃O₅.

Thus, the metal-substituted titanium oxide of MnₓTi₍₃₋ₓ₎O₅ is able to maintain a paramagnetic metal state over the entire temperature range of 0 to 800 [K] because it does not undergo phase transition to a crystal structure of β-Ti₃O₅ of a nonmagnetic semiconductor at a temperature of 460 [K] or lower. In addition, the metal-substituted titanium oxide of MnₓTi₍₃₋ₓ₎O₅ is able to show an X-ray diffraction peak of β-Ti₃O₅ in X-ray diffraction, and undergo phase transition from a crystal structure in a paramagnetic metal state to a monoclinic crystal structure as a nonmagnetic semiconductor upon application of pressure or light at the time of having a monoclinic crystal structure in a paramagnetic metal state with which an X-ray diffraction peak of λ-Ti₃O₅ is shown in X-ray diffraction.

Since the metal-substituted titanium oxide sintered body composed of a metal-substituted titanium oxide of MnₓTi₍₃₋ₓ₎O₅ can be produced in accordance with the production method described above in “(1) Outline of metal-substituted titanium oxide of invention” including sintering conditions in production, the description thereof is omitted here in order to avoid repetition in description.

(3-1) Verification Test

Next, the metal-substituted titanium oxide of MnₓTi₍₃₋ₓ₎O₅ was produced in accordance with the production method described above in “(1) Outline of metal-substituted titanium oxide of invention”, and the X-ray diffraction pattern of the metal-substituted titanium oxide was examined. Specifically, a sol-like dispersion liquid (trade name “STS-01” manufactured by Ishihara Sangyo Kaisha, Ltd.) was prepared in which TiO₂ particles having an X-ray particle diameter of about 7 [nm] are mixed in an aqueous nitric acid solution at a concentration of 30 [wt %].

Manganese sulfate (MnSO₄.5H₂O) was then dissolved in the dispersion liquid, the resulting solution was stirred to homogenize the solution, and a precipitant (aqueous ammonia) was then mixed therewith to generate a mixed solution. Here, the amount of the manganese sulfate was adjusted to set the atomic ratio between Mn and Ti in the mixed solution to Mn:Ti=2:98, Mn:Ti=4:96, Mn:Ti=6:94, Mn:Ti=8:92 and Mn:Ti=10:90.

Each mixed solution was then centrifuged to separate particles composed of titanium oxide (TiO₂) and manganese hydroxide (Mn(OH)₂) from the mixed solution, and these particles were then washed and dried, whereby particles composed of titanium oxide and manganese hydroxide were extracted from the mixed solution to obtain a precursor powder.

The precursor powder as an aggregate of particles composed of titanium oxide and manganese hydroxide was then sintered at a predetermined temperature (1050° C.) for a predetermined time (about 5 hours) under a hydrogen atmosphere (0.7 L/min). Through the sintering treatment, the particles composed of titanium oxide and manganese hydroxide were subjected to a reduction reaction with hydrogen, so that Ti⁴⁺ was reduced to generate a metal-substituted titanium oxide sintered body composed of a metal-substituted titanium oxide in which a part of Ti₃O₅ being an oxide containing Ti³⁺ is substituted with Mn. In addition, separately, a titanium oxide sintered body composed of λ-Ti₃O₅ in Japanese Patent No. 5398025 as described in “(2-1) Verification test” was generated as a comparative example, separately from the above-mentioned mixed solutions.

For the thus-produced powders composed of metal-substituted titanium oxide sintered bodies (sintered powders) having different atomic ratios between Mn and Ti, X-ray fluorescence (XRF) analysis was performed, and it was possible to confirm that there were no impurity elements. In addition, as a result of X-ray fluorescence analysis, it was possible to confirm that the metal-substituted titanium oxide sintered body produced from a mixed solution adjusted to a Mn:Ti ratio of 2:98 in the production process had a Mn:Ti ratio of 3:97, and a composition of MnₓTi₍₃₋ₓ₎O₅ (x=0.08).

In addition, as a result of X-ray fluorescence analysis, it was possible to confirm that the metal-substituted titanium oxide sintered body produced from a mixed solution adjusted to a Mn:Ti ratio of 4:96 in the production process had a Mn:Ti ratio of 4:96, and a composition of MnₓTi₍₃₋ₓ₎O₅ (x=0.13), and further, as a result of X-ray fluorescence analysis, it was possible to confirm that the metal-substituted titanium oxide sintered body produced from a mixed solution adjusted to a Mn:Ti ratio of 6:94 in the production process had a Mn:Ti ratio of 6:94, and a composition of MnₓTi₍₃₋ₓ₎O₅ (x=0.18).

As a result of X-ray fluorescence analysis, it was possible to confirm that the metal-substituted titanium oxide sintered body produced from a mixed solution adjusted to a Mn:Ti ratio of 8:92 in the production process had a Mn:Ti ratio of 8:92, and a composition of MnₓTi₍₃₋ₓ₎O₅ (x=0.25), and further, as a result of X-ray fluorescence analysis, it was possible to confirm that the metal-substituted titanium oxide sintered body produced from a mixed solution adjusted to a Mn:Ti ratio of 10:90 in the production process had a Mn:Ti ratio of 10:90, and a composition of MnₓTi₍₃₋ₓ₎O₅ (x=0.30). Hereinafter, each sintered powder will be distinctively described with the value of x.

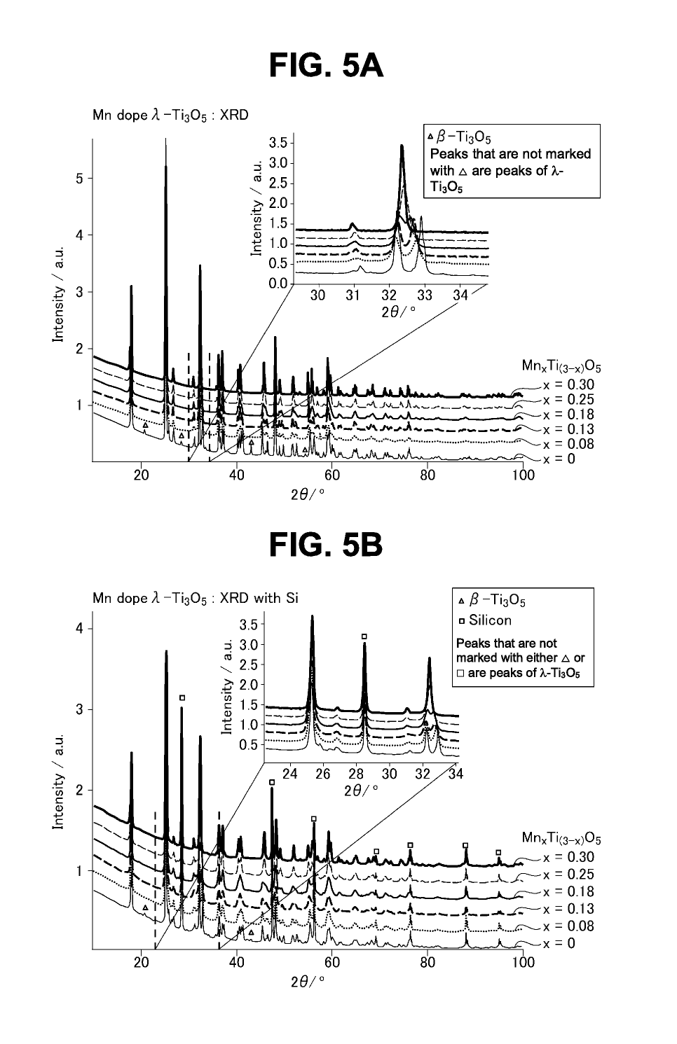

Next, the X-ray diffraction pattern was measured at room temperature for each of the sintered powders and a powder composed of a titanium oxide sintered body of Ti₃O₅ (Ti₃O₅ sintered powder), and results shown in FIG. 5A were obtained. FIG. 5A shows a diffraction angle on the abscissa, and an X-ray diffraction intensity on the ordinate, where the X-ray diffraction pattern of Ti₃O₅ disclosed in Japanese Patent No. 5398025 in which a Ti site is not substituted with Mn is indicated by “x=0”.

Comparison of the X-ray diffraction patterns of the sintered powders with the X-ray diffraction pattern of the Ti₃O₅ sintered powder revealed that as shown in FIG. 5A, the X-ray diffraction pattern of the Ti₃O₅ sintered powder (x=0) showed two X-ray diffraction peaks, for example, at a diffraction angle around 32 degrees to 33 degrees. On the other hand, it was possible to confirm that the X-ray diffraction patterns of the sintered powders wherein x=0.08, x=0.13 and x=0.18 each showed two X-ray diffraction peaks similarly at a diffraction angle around 32 degrees to 33 degrees although the X-ray diffraction peaks had a lower height as compared to λ-Ti₃O₅.

Thus, it was possible to confirm that the sintered powders wherein x=0.08, x=0.13 and x=0.18 had the same crystal structure as the crystal structure of λ-Ti₃O₅ in the Ti₃O₅ sintered powder. In addition, it was possible to confirm that the sintered powders wherein x=0.08, x=0.13 and x=0.18 had none of crystal structures of α-Ti₃O₅ and β-Ti₃O₅ because they did not show an X-ray diffraction peak of α-Ti₃O₅ and an X-ray diffraction peak of β-Ti₃O₅.

On the other hand, it was possible to confirm that the X-ray diffraction pattern of the sintered powder wherein x=0.25 as a comparative example, and the X-ray diffraction pattern of the sintered powder wherein x=0.30 also as a comparative example showed one sharp X-ray diffraction peak similarly at a diffraction angle around 32 degrees to 33 degrees unlike the Ti₃O₅ sintered powder. Thus, it was possible to confirm that the sintered powders wherein x=0.25 and x=0.30 were different in crystal structure from the Ti₃O₅ sintered powder, and did not have a crystal structure of λ-Ti₃O₅ as in the Ti₃O₅ sintered powder.

Next, for examining an X-ray diffraction peak shift caused by an error in an X-ray diffraction apparatus, etc., Si as a standard substance for giving a standard of an X-ray diffraction peak was physically mixed with the sintered powders wherein x=0.08, x=0.13, x=0.18, x=0.25 and x=0.30 and the Ti₃O₅ sintered powder wherein x=0 described above.

For each of the thus-produced powders composed of metal-substituted titanium oxide sintered bodies having different atomic ratios between Mn and Ti (sintered powders) and powder composed of a titanium oxide sintered body of Ti₃O₅ (Ti₃O₅ sintered powder), the X-ray diffraction pattern was measured at room temperature as described above, and results shown in FIG. 5B were obtained.

From FIG. 5B, it was also possible to confirm from the positions of X-ray diffraction peaks that the sintered powders wherein x=0.08, x=0.13 and x=0.18 had a crystal structure including a crystal structure of λ-Ti₃O₅ in the sintered powder. Thus, it was possible to confirm that the sintered powders wherein x=0.08, x=0.13 and x=0.18 maintained a crystal structure in a paramagnetic metal state even at a temperature of 460 [K] or lower because they had the same crystal structure of λ-Ti₃O₅ in a paramagnetic metal state as that of the Ti₃O₅ sintered powder rather than a crystal structure of β-Ti₃O₅ of a nonmagnetic semiconductor.

Thus, it was possible to confirm that the metal-substituted titanium oxide of MnₓTi₍₃₋ₓ₎O₅ (0<x≤0.18) was able to maintain a paramagnetic metal state because it did not show an X-ray diffraction peak of β-Ti₃O₅ even at 460 [K] or lower, and showed an X-ray diffraction peak of λ-Ti₃O₅. The metal-substituted titanium oxide of MnₓTi₍₃₋ₓ₎O₅ (0<x≤0.18) is able to maintain a paramagnetic metal state over the entire temperature range of 0 to 800 [K].

Next, for the sintered powders having different atomic ratios between Mn and Ti and the Ti₃O₅ sintered powder, the lattice constant was examined by performing Rietveld analysis from the X-ray diffraction pattern shown in FIG. 5A, and the result showed that for β[°], there was a negative correlation with respect to the content of Mn at x=0.08 to 0.30. In the sintered powders wherein x=0.08, x=0.13 and x=0.18, the crystal structure belongs to a space group C2/m.

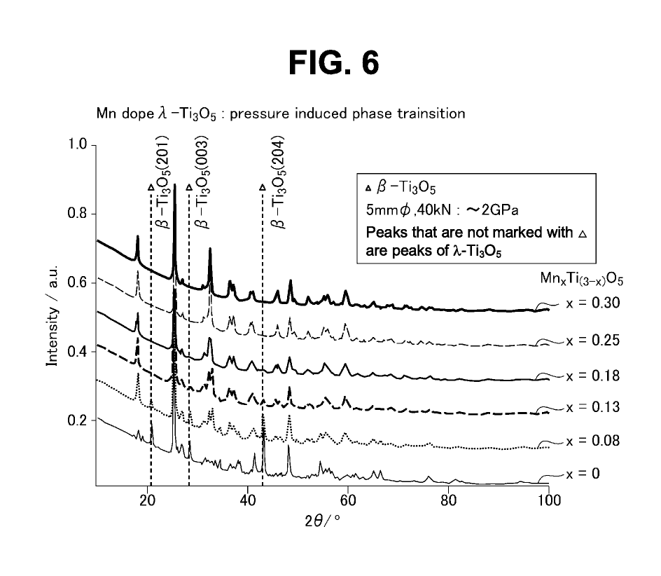

Next, a pressure of 40 [kN] (up to 2 [GPa]) was applied to the sintered powders having different atomic ratios between Mn and Ti and the Ti₃O₅ sintered powder in a tablet molding machine for IR, which is capable of molding pellets of 5 mmφ, and the X-ray diffraction pattern was examined after release of pressure. Consequently, results shown in FIG. 6 were obtained. It was possible to confirm that the sintered powders wherein x=0.08, x=0.13 and x=0.18 had the same crystal structure as that of Ti₃O₅ sintered powder because they showed a characteristic X-ray diffraction peak at the same position as in the Ti₃O₅ sintered powder after application of pressure as shown in FIG. 6.

In addition, as in the case of the same Ti₃O₅ sintered powder as in Japanese Patent No. 5398025, the sintered powders wherein x=0.08 and x=0.13 showed an X-ray diffraction peak at each of diffraction angles of 21 degrees, 28 degrees and 43 degrees when pressure was applied. Thus, it was possible to confirm that as in the case of the Ti₃O₅ sintered powder, the sintered powders wherein x=0.08 and x=0.13 underwent phase transition from a crystal structure of λ-Ti₃O₅ to a crystal structure of β-Ti₃O₅ when pressure was applied.

For the sintered powder wherein x=0.18, it was also possible to confirm that an X-ray diffraction peak of β-Ti₃O₅ was shown, so that the crystal structure was confirmed to undergo phase transition. Thus, it was possible to confirm that the sintered powders wherein x=0.08, x=0.13 and x=0.18 had a crystal structure which undergoes phase transition from a crystal structure of λ-Ti₃O₅ in a paramagnetic metal state to a crystal structure of a nonmagnetic semiconductor upon application of pressure.

Next, pellets were prepared using the sintered powder wherein x=0.13, water glass was poured to the pellets to prepare a sample to be irradiated with light, the sample was then irradiated with laser light, and the state of the surface of the sample was examined. The sample was irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored, indicating that the crystal structure underwent phase transition.

In addition, the discolored portion of the sample was further irradiated with 532 [nm] pulse laser light (Nd³⁺ YAG laser) of 1.7×10⁻⁶ mJ m⁻² pulse⁻¹, a portion subjected to a predetermined light intensity by the pulse laser light was examined, and it was possible to confirm that the portion irradiated with the pulse laser light was slightly discolored, indicating that the crystal structure underwent phase transition.

The portion irradiated with pulse laser light in the sample was further irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored again, indicating that the crystal structure underwent phase transition. Thus, it was possible to confirm that in the sintered powder wherein x=0.08, the crystal structure also underwent phase transition when irradiated with light.

(3-2) Action and Effects

With the above configuration, in the present invention, a mixed solution containing TiO₂ particles and Mn in a predetermined amount is prepared, particles composed of TiO₂ and Mn are generated in the mixed solution, and a precursor powder composed of particles extracted from the mixed solution is sintered under a hydrogen atmosphere, whereby it is possible to produce a metal-substituted titanium oxide sintered body composed of a metal-substituted titanium oxide in which some of Ti sites of Ti₃O₅ are substituted with Mn.

The metal-substituted titanium oxide that forms the metal-substituted titanium oxide sintered body is able to have a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a nonmagnetic semiconductor upon application of pressure or light. Thus, according to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields.

(4) Metal-Substituted Titanium Oxide in Which Some of Ti Sites of Ti₃O₅ are Substituted with Al

A metal-substituted titanium oxide in which some of Ti sites of Ti₃O₅ are substituted with Al will now be described. The metal-substituted titanium oxide has a composition in which one Ti³⁺ in λ-Ti₃O₅ having a composition of Ti³⁺₂Ti⁴⁺O₅ is substituted with Al³⁺, e.g. a composition of AlₓTi₍₃₋ₓ₎O₅ (0<x≤0.51). The metal-substituted titanium oxide of AlₓTi₍₃₋ₓ₎O₅ is able to have a monoclinic crystal structure maintaining a paramagnetic metal state because it shows an X-ray diffraction peak of λ-Ti₃O₅ in X-ray diffraction at a temperature of 460 [K] or lower as in the case of λ-Ti₃O₅.

Thus, the metal-substituted titanium oxide of AlₓTi₍₃₋ₓ₎O₅ is able to maintain a paramagnetic metal state over the entire temperature range of 0 to 800 [K] because it does not undergo phase transition to a crystal structure of β-Ti₃O₅ of a nonmagnetic semiconductor at a temperature of 460 [K] or lower. In addition, the metal-substituted titanium oxide of AlₓTi₍₃₋ₓ₎O₅ is able to show an X-ray diffraction peak of β-Ti₃O₅ in X-ray diffraction, and undergo phase transition from a crystal structure in a paramagnetic metal state to a crystal structure as a nonmagnetic semiconductor upon application of pressure or light at the time of having a crystal structure in a paramagnetic metal state with which an X-ray diffraction peak of λ-Ti₃O₅ is shown in X-ray diffraction.

Since a metal-substituted titanium oxide sintered body 1 composed of a metal-substituted titanium oxide of AlₓTi₍₃₋ₓ₎O₅ can be produced in accordance with the production method described above in “(1) Outline of metal-substituted titanium oxide of invention” including sintering conditions in production, the description thereof is omitted here in order to avoid repetition in description.

(4-1) Verification Test

Next, the metal-substituted titanium oxide of AlₓTi₍₃₋ₓ₎O₅ was produced in accordance with the production method described above in “(1) Outline of metal-substituted titanium oxide of invention”, and the X-ray diffraction pattern of the metal-substituted titanium oxide was examined. Specifically, a sol-like dispersion liquid (trade name “STS-01” manufactured by Ishihara Sangyo Kaisha, Ltd.) was prepared in which TiO₂ particles having an X-ray particle diameter of about 7 [nm] are mixed in an aqueous nitric acid solution at a concentration of 30 [wt %].

Aluminum sulfate (Al₂(SO₄)₃.16H₂O) was then dissolved in the dispersion liquid, the resulting solution was stirred to homogenize the solution, and a precipitant (aqueous ammonia) was then mixed therewith to generate a mixed solution. Here, the amount of the aluminum sulfate was adjusted to set the atomic ratio between Al and Ti in the mixed solution to Al:Ti=2:98, Al:Ti=4:96, Al:Ti=6:94, Al:Ti=8:92 and Al:Ti=10:90.

Each mixed solution was then centrifuged to separate particles composed of titanium oxide (TiO₂) and aluminum hydroxide (Al(OH)₃) from the mixed solution, and these particles were then washed and dried, whereby particles composed of titanium oxide and aluminum hydroxide were extracted from the mixed solution to obtain a precursor powder.

The precursor powder as an aggregate of particles composed of titanium oxide and aluminum hydroxide was then sintered at a predetermined temperature (1100° C.) for a predetermined time (about 5 hours) under a hydrogen atmosphere (0.7 L/min). Through the sintering treatment, the particles composed of titanium oxide and aluminum hydroxide were subjected to a reduction reaction with hydrogen, so that Ti⁴⁺ was reduced to generate a metal-substituted titanium oxide sintered body composed of a metal-substituted titanium oxide in which a part of Ti₃O₅ being an oxide containing Ti³⁺ is substituted with Al. In addition, separately, a titanium oxide sintered body composed of λ-Ti₃O₅ in Japanese Patent No. 5398025 as described in “(2-1) Verification test” was generated as a comparative example, separately from the above-mentioned mixed solutions.

For the thus-produced powders composed of metal-substituted titanium oxide sintered bodies (sintered powders) having different atomic ratios between Al and Ti, X-ray fluorescence (XRF) analysis was performed, and it was possible to confirm that there were no impurity elements. In addition, as a result of X-ray fluorescence analysis, it was possible to confirm that the metal-substituted titanium oxide sintered body produced from a mixed solution adjusted to an Al:Ti ratio of 2:98 in the production process had an Al:Ti ratio of 4:96, and a composition of AlₓTi₍₃₋ₓ₎O₅ (x=0.13).

In addition, as a result of X-ray fluorescence analysis, it was possible to confirm that the metal-substituted titanium oxide sintered body produced from a mixed solution adjusted to an Al:Ti ratio of 4:96 in the production process had an Al:Ti ratio of 8:92, and a composition of AlₓTi₍₃₋ₓ₎O₅ (x=0.24), and further, as a result of X-ray fluorescence analysis, it was possible to confirm that the metal-substituted titanium oxide sintered body produced from a mixed solution adjusted to an Al:Ti ratio of 6:94 in the production process had an Al:Ti ratio of 11:89, and a composition of AlₓTi₍₃₋ₓ₎O₅ (x=0.33).

As a result of X-ray fluorescence analysis, it was possible to confirm that the metal-substituted titanium oxide sintered body produced from a mixed solution adjusted to an Al:Ti ratio of 8:92 in the production process had an Al:Ti ratio of 15:85, and a composition of AlₓTi₍₃₋ₓ₎O₅ (x=0.44), and further, as a result of X-ray fluorescence analysis, it was possible to confirm that the metal-substituted titanium oxide sintered body produced from a mixed solution adjusted to an Al:Ti ratio of 10:90 in the production process had an Al:Ti ratio of 17:83, and a composition of AlₓTi₍₃₋ₓ₎O₅ (x=0.51). Hereinafter, each sintered powder will be distinctively described with the value of x.

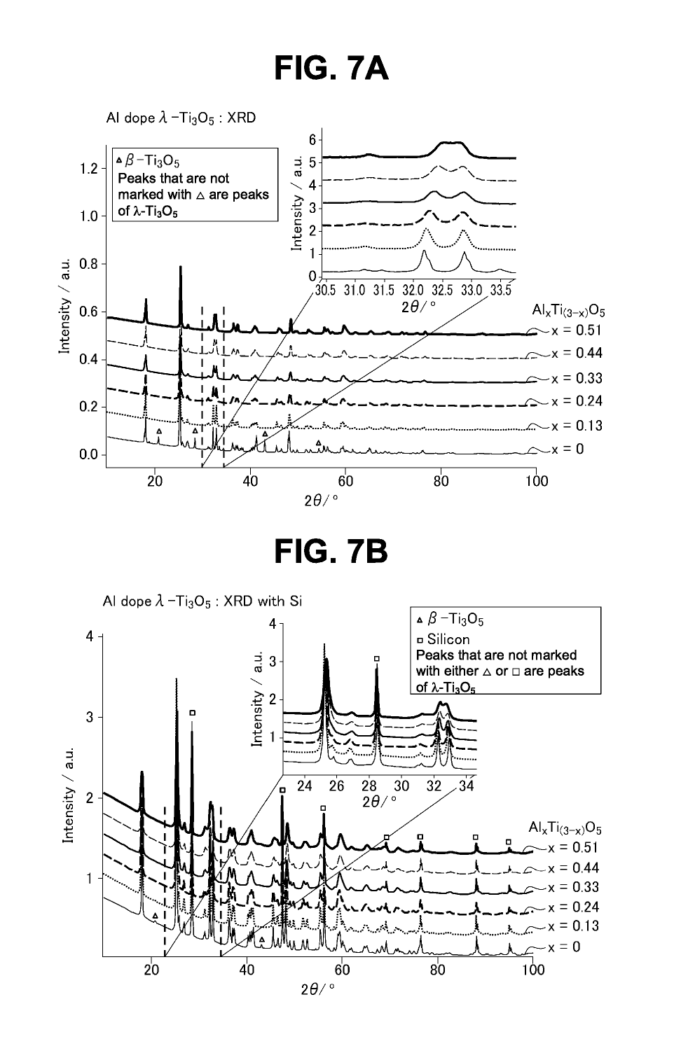

Next, the X-ray diffraction pattern was measured at room temperature for each of the sintered powders and a powder composed of a titanium oxide sintered body of Ti₃O₅ (Ti₃O₅ sintered powder), and results shown in FIG. 7A were obtained. FIG. 7A shows a diffraction angle on the abscissa, and an X-ray diffraction intensity on the ordinate, where the X-ray diffraction pattern of Ti₃O₅ disclosed in Japanese Patent No. 5398025 in which a Ti site is not substituted with Al is indicated by “x=0”.

Comparison of the X-ray diffraction patterns of the sintered powders with the X-ray diffraction pattern of the Ti₃O₅ sintered powder revealed that as shown in FIG. 7A, the X-ray diffraction pattern of the Ti₃O₅ sintered powder (x=0) showed two X-ray diffraction peaks, for example, at a diffraction angle around 32 degrees to 33 degrees. On the other hand, it was possible to confirm that the X-ray diffraction patterns of the sintered powders wherein x=0.13, x=0.24, x =0.33 and x=0.44 each showed two X-ray diffraction peaks similarly at a diffraction angle around 32 degrees to 33 degrees although the X-ray diffraction peaks had a lower height as compared to λ-Ti₃O₅.

In addition, it was possible to confirm that the X-ray diffraction pattern of the sintered powder wherein x=0.51 slightly showed two trapezoidal peaks similarly at a diffraction angle around 32 degrees to 33 degrees although the peaks did not have a valley as clearly observable as that in the case of the Ti₃O₅ sintered powder. Thus, it was possible to confirm that the sintered powders wherein x=0.13, x=0.24, x=0.33, x=0.44 and x=0.51 each had the same crystal structure as the crystal structure of λ-Ti₃O₅ in the Ti₃O₅ sintered powder. In addition, it was possible to confirm that the sintered powders wherein x=0.13, x=0.24, x=0.33, x=0.44 and x=0.51 each had none of crystal structures of α-Ti₃O₅ and β-Ti₃O₅ because they did not show an X-ray diffraction peak of α-Ti₃O₅ and an X-ray diffraction peak of β-Ti₃O₅.

Next, for examining an X-ray diffraction peak shift caused by an error in an X-ray diffraction apparatus, etc., Si as a standard substance for giving a standard of an X-ray diffraction peak was physically mixed with the sintered powders wherein x=0.13, x=0.24, x=0.33, x=0.44 and x=0.51 and the Ti₃O₅ sintered powder wherein x=0 described above.

For each of the thus-produced powders composed of metal-substituted titanium oxide sintered bodies having different atomic ratios between Al and Ti (sintered powders) and powder composed of a titanium oxide sintered body of Ti₃O₅ (Ti₃O₅ sintered powder), the X-ray diffraction pattern was measured at room temperature as described above, and results shown in FIG. 7B were obtained.

From FIG. 7B, it was also possible to confirm from the positions of X-ray diffraction peaks that the sintered powders wherein x=0.13, x=0.24, x=0.33, x=0.44 and x=0.51 each had a crystal structure including a crystal structure of λ-Ti₃O₅ in the sintered powder. It was possible to confirm that particularly, the sintered powder wherein x=0.51 showed two X-ray diffraction peaks sharper than those in FIG. 7A at a diffraction angle around 32 degrees to 33 degrees. Thus, it was possible to confirm that the sintered powders wherein x=0.13, x=0.24, x=0.33, x=0.44 and x=0.51 maintained a crystal structure in a paramagnetic metal state even at a temperature of 460 [K] or lower because they had the same crystal structure of λ-Ti₃O₅ in a paramagnetic metal state as that of the Ti₃O₅ sintered powder rather than a crystal structure of β-Ti₃O₅ of a nonmagnetic semiconductor.

Thus, it was possible to confirm that the metal-substituted titanium oxide of AlₓTi₍₃₋ₓ₎O₅ (0<x≤0.51) was able to maintain a paramagnetic metal state because it did not show an X-ray diffraction peak of β-Ti₃O₅ even at 460 [K] or lower, and showed an X-ray diffraction peak of λ-Ti₃O₅. The metal-substituted titanium oxide of AlₓTi₍₃₋ₓ₎O₅ (0<x≤0.51) is able to maintain a paramagnetic metal state over the entire temperature range of 0 to 800 [K].

Next, for the sintered powders having different atomic ratios between Al and Ti and the Ti₃O₅ sintered powder, the lattice constant was examined by performing Rietveld analysis from the X-ray diffraction pattern shown in FIG. 7A, and the result showed that for β[°], there was a negative correlation with respect to the content of Al at x=0.03 to 0.51. In the sintered powders wherein x=0.13, x=0.24, x=0.33, x=0.44 and x=0.51, the crystal structure belongs to a space group C2/m.

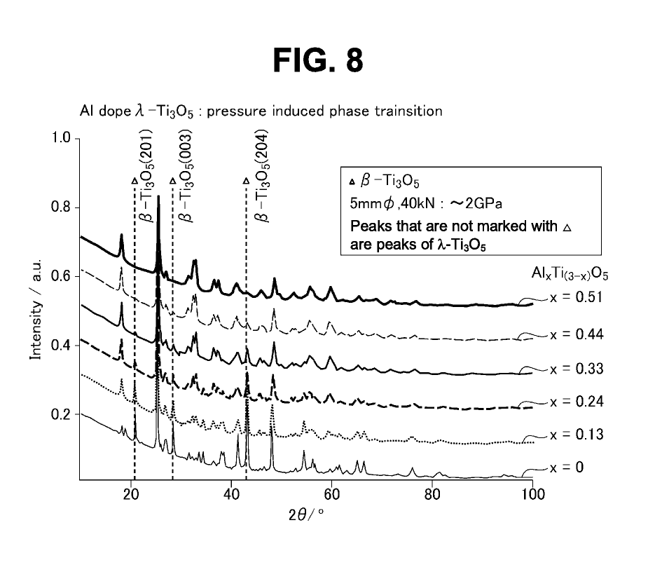

Next, a pressure of 40 [kN] (up to 2 [GPa]) was applied to the sintered powders having different atomic ratios between Al and Ti and the Ti₃O₅ sintered powder in a tablet molding machine for IR, which is capable of molding pellets of 5 mmφ, and the X-ray diffraction pattern was examined after release of pressure. Consequently, results shown in FIG. 8 were obtained. It was possible to confirm that the sintered powders wherein x=0.13, x=0.24, x=0.33, x=0.44 and x=0.51 each had the same crystal structure as that of Ti₃O₅ sintered powder because they showed a characteristic X-ray diffraction peak at the same position as in the Ti₃O₅ sintered powder after application of pressure as shown in FIG. 8.

In addition, as in the case of the same Ti₃O₅ sintered powder as in Japanese Patent No. 5398025, the sintered powders wherein x=0.13, x=0.24 and x=0.33 each showed an X-ray diffraction peak at each of diffraction angles of 21 degrees, 28 degrees and 43 degrees when pressure was applied. Thus, it was possible to confirm that as in the case of the Ti₃O₅ sintered powder, the sintered powders wherein x=0.13, x=0.24 and x=0.33 underwent phase transition from a crystal structure of λ-Ti₃O₅ to a crystal structure of β-Ti₃O₅ when pressure was applied.

Further, for the sintered powders wherein x=0.44 and x=0.51, it was also possible to confirm that an X-ray diffraction peak of β-Ti₃O₅ was shown, so that the crystal structure was confirmed to undergo phase transition. Thus, it was possible to confirm that the sintered powders wherein x=0.13, x=0.24, x=0.33, x=0.44 and x=0.51 each had a crystal structure which undergoes phase transition from a crystal structure of λ-Ti₃O₅ in a paramagnetic metal state to a nonmagnetic semiconductor upon application of pressure.

Next, pellets were prepared using the sintered powder wherein x=0.24, water glass was poured to the pellets to prepare a sample to be irradiated with light, the sample was then irradiated with laser light, and the state of the surface of the sample was examined. The sample was irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored, indicating that the crystal structure underwent phase transition.

In addition, the discolored portion of the sample was further irradiated with 532 [nm] pulse laser light (Nd³⁺ YAG laser) of 1.7×10⁻⁶ mJ m⁻² pulse⁻¹, a portion subjected to a predetermined light intensity by the pulse laser light was examined, and it was possible to confirm that the portion irradiated with the pulse laser light was slightly discolored, indicating that the crystal structure underwent phase transition.

The irradiated portion of the sample was further irradiated with 532 [nm] pulse laser light (Nd³⁺ YAG laser) of 1.1×10⁻⁵ mJ m⁻² pulse⁻¹, a portion subjected to a predetermined light intensity by the pulse laser light was examined, and it was possible to confirm that the portion irradiated with the pulse laser light was discolored again, indicating that the crystal structure underwent phase transition. Thus, it was possible to confirm that in the sintered powder wherein x=0.24, the crystal structure also underwent phase transition when irradiated with light.

(4-2) Action and Effects

With the above configuration, in the present invention, a mixed solution containing TiO₂ particles and Al in a predetermined amount is prepared, particles composed of TiO₂ and Al are generated in the mixed solution, and a precursor powder composed of particles extracted from the mixed solution is sintered under a hydrogen atmosphere, whereby it is possible to produce a metal-substituted titanium oxide sintered body composed of a metal-substituted titanium oxide in which some of Ti sites of Ti₃O₅ are substituted with Al.

The metal-substituted titanium oxide that forms the metal-substituted titanium oxide sintered body is able to have a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a nonmagnetic semiconductor upon application of pressure or light. Thus, according to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields.

(5) Metal-Substituted Titanium Oxide in Which Some of Ti Sites of Ti₃O₅ are Substituted with V

A metal-substituted titanium oxide in which some of Ti sites of Ti₃O₅ are substituted with V will now be described. The metal-substituted titanium oxide has a composition in which two Ti²⁺ in λ-Ti₃O₅ having a composition of Ti³⁺₂Ti⁴⁺O₅ are substituted with V²⁺ and Ti⁴⁺, e.g. a composition of VₓTi₍₃₋ₓ₎O₅ (0<x≤0.18). The metal-substituted titanium oxide of VₓTi₍₃₋ₓ₎O₅ is able to have a monoclinic crystal structure maintaining a paramagnetic metal state because it shows an X-ray diffraction peak of λ-Ti₃O₅ in X-ray diffraction at a temperature of 460 [K] or lower as in the case of λ-Ti₃O₅.

Thus, the metal-substituted titanium oxide of VₓTi₍₃₋ₓ₎O₅ is able to maintain a paramagnetic metal state over the entire temperature range of 0 to 800 [K] because it does not undergo phase transition to a crystal structure of β-Ti₃O₅ of a nonmagnetic semiconductor at a temperature of 460 [K] or lower. In addition, the metal-substituted titanium oxide of VₓTi₍₃₋ₓ₎O₅ is able to show an X-ray diffraction peak of β-Ti₃O₅ in X-ray diffraction, and undergo phase transition from a crystal structure in a paramagnetic metal state to a crystal structure as a nonmagnetic semiconductor upon application of pressure or light at the time of having a crystal structure in a paramagnetic metal state with which an X-ray diffraction peak of λ-Ti₃O₅ is shown in X-ray diffraction.

Since a metal-substituted titanium oxide sintered body 1 composed of a metal-substituted titanium oxide of VₓTi₍₃₋ₓ₎O₅ can be produced in accordance with the production method described above in “(1) Outline of metal-substituted titanium oxide of invention” including sintering conditions in production, the description thereof is omitted here in order to avoid repetition in description. It is desirable that the atomic ratio between V and Ti in the mixed solution in production be (V:Ti)=(more than 0:less than 100) to (6:94).

Thus, the metal-substituted titanium oxide in which some of Ti sites of Ti₃O₅ are substituted with V is also able to have a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to monoclinic crystal structure, which is a nonmagnetic semiconductor, upon application of pressure or light. Thus, according to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields.

(6) Metal-Substituted Titanium Oxide in Which Some of Ti Sites of Ti₃O₅ are Substituted with Nb

A metal-substituted titanium oxide in which some of Ti sites of Ti₃O₅ are substituted with Nb will now be described. The metal-substituted titanium oxide has a composition in which one Ti³⁺ in λ-Ti₃O₅ having a composition of Ti³⁺₂Ti⁴⁺O₅ is substituted with Nb³⁺, e.g. a composition of NbₓTi₍₃₋ₓ₎O₅ (0<x≤0.18). The metal-substituted titanium oxide of NbₓTi₍₃₋ₓ₎O₅ is able to have a monoclinic crystal structure maintaining a paramagnetic metal state because it shows an X-ray diffraction peak of λ-Ti₃O₅ in X-ray diffraction at a temperature of 460 [K] or lower as in the case of λ-Ti₃O₅.

Thus, the metal-substituted titanium oxide of NbₓTi₍₃₋ₓ₎O₅ is able to maintain a paramagnetic metal state over the entire temperature range of 0 to 800 [K] because it does not undergo phase transition to a crystal structure of β-Ti₃O₅ of a nonmagnetic semiconductor at a temperature of 460 [K] or lower. In addition, the metal-substituted titanium oxide of NbₓTi₍₃₋ₓ₎O₅ is able to show an X-ray diffraction peak of β-Ti₃O₅ in X-ray diffraction, and undergo phase transition from a crystal structure in a paramagnetic metal state to a crystal structure as a nonmagnetic semiconductor upon application of pressure or light at the time of having a crystal structure in a paramagnetic metal state with which an X-ray diffraction peak of λ-Ti₃O₅ is shown in X-ray diffraction.

Since a metal-substituted titanium oxide sintered body 1 composed of a metal-substituted titanium oxide of NbₓTi₍₃₋ₓ₎O₅ can be produced in accordance with the production method described above in “(1) Outline of metal-substituted titanium oxide of invention” including sintering conditions in production, the description thereof is omitted here in order to avoid repetition in description. It is desirable that the atomic ratio between Nb and Ti in the mixed solution in production be (Nb:Ti)=(more than 0:less than 100) to (6:94).

Thus, the metal-substituted titanium oxide in which some of Ti sites of Ti₃O₅ are substituted with Nb is also able to have a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to monoclinic crystal structure, which is a nonmagnetic semiconductor, upon application of pressure or light. Thus, according to the present invention, it is possible to provide a metal-substituted titanium oxide which has a composition other than conventional Ti₃O₅ while having a property of being able to undergo phase transition from a crystal structure in a paramagnetic metal state to a crystal structure of a nonmagnetic semiconductor upon application of pressure or light and which can also be used in fields other than conventional technical fields.

(7) Verification Test for Metal-Substituted Titanium Oxide of MgₓTi₍₃₋ₓ₎O₅ (x=0.005, x=0.009, x=0.017 and x=0.034)

Here, for the “(2) Metal-substituted titanium oxide in which some of Ti sites of Ti₃O₅ are substituted with Mg” as described above, a magnetization was measured by SQUID (Superconducting quantum interference device) and the phase transition temperature of the crystal structure was examined by DSC (Differential scanning calorimetry) while the value of x was changed. By the same production method as described above in “(2-1) Verification test”, metal-substituted titanium oxide sintered bodies composed of metal-substituted titanium oxides of MgₓTi₍₃₋ₓ₎O₅ with different values of x were produced. Sintered powders composed of the metal-substituted titanium oxide sintered bodies were prepared as samples.

Specifically, sintered powders of metal-substituted titanium oxide sintered bodies composed of metal-substituted titanium oxides of MgₓTi₍₃₋ₓ₎O₅ with the values of x being 0.005, 0.009, 0.017 and 0.034, respectively, were prepared. In addition, as a comparative example, a Ti₃O₅ sintered powder wherein x=0 (sintered powder of λ-Ti₃O₅ disclosed in Japanese Patent No. 5398025) was also prepared as in the “(2-1) Verification test” as described above.

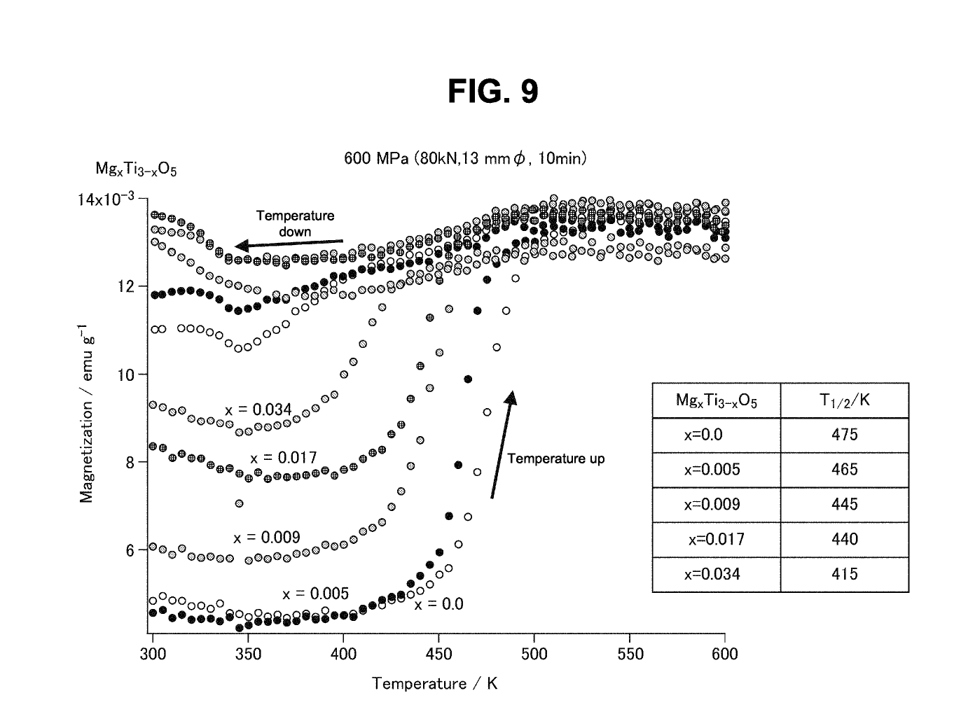

In the verification test, the sintered powders of metal-substituted titanium oxide sintered bodies of MgₓTi₍₃₋ₓ₎O₅ (x=0.005, x=0.009, x=0.017 or x=0.034) and the Ti₃O₅ sintered powder were subjected to pressure at 600 [MPa] (80 [kN], 10 [min]) to prepare samples of 13 [mmφ]. These samples were each heated from 300 [K] to 600 [K] while the magnetization was measured by SQUID. Thereafter, these samples were each cooled from 600 [K] to 300 [K] while the magnetization was measured by SQUID. Consequently, results shown in FIG. 9 were obtained.

From FIG. 9, it was possible to confirm that in the sintered powder subjected to pressure before being heated, the magnetization increased as the value of x in MgₓTi₍₃₋ₓ₎O₅ became larger. The sintered powders of metal-substituted titanium oxide sintered bodies of MgₓTi₍₃₋ₓ₎O₅ (x=0.005, x=0.009, x=0.017 or x=0.034) each had a magnetization of 10 [emu g⁻¹] or less as a result of being subjected to pressure. It was possible to confirm that in the sintered powders of MgₓTi₍₃₋ₓ₎O₅ (x=0.005, x=0.009, x=0.017 or x=0.034), the crystal structure underwent phase transition because when the temperature was elevated from 300 [K] to 600 [K], the magnetization rapidly increased at a certain temperature as in the case of the Ti₃O₅ sintered powder.

“T_{1/2}/K” in the table in FIG. 9 represents a phase transition temperature that is a temperature at which the magnetic susceptibility is intermediate between a magnetic susceptibility at 350 [K] before the crystal structure undergoes phase transition and a magnetic susceptibility at 550 [K] after the crystal structure undergoes phase transition. From the results of measuring “T_{1/2}/K”, it was possible to confirm that the phase transition temperature of the crystal structure decreased as the value of x in MgₓTi₍₃₋ₓ₎O₅ became larger.

Even when the temperature was decreased from 600 [K] to 300 [K], the sintered powders of MgₓTi₍₃₋ₓ₎O₅ with the values of x being 0.005, 0.009, 0.017 or 0.034, respectively, still maintained a high magnetization attained after elevation of the temperature as in the case of the Ti₃O₅ sintered powder, and from this result, it was possible to confirm that these sintered powders did not undergo phase transition to a crystal structure having the properties of a nonmagnetic semiconductor even at 460 [K] or lower. Thus, these sintered powders show a behavior similar to that of the Ti₃O₅ sintered powder in terms of magnetization, and therefore can be said to have Pauli paramagnetism and maintain a paramagnetic metal state over the entire temperature range of 0 to 800 [K] as in the case of the Ti₃O₅ sintered powder.

In FIG. 9, the magnetization at a temperature higher than 600 [K] is not examined, as in the case of the conventional Ti₃O₅ sintered powder, but a paramagnetic metal state can be maintained even at 800 [K] that is a temperature above 600 [K] because at least there is no rapid change in magnetization at 500 [K] or higher. In addition, the magnetization at a temperature lower than 300 [K] is not examined, but a paramagnetic metal state can be maintained even at a temperature lower than 300 [K] because there is no rapid change in magnetization.

It was possible to confirm that as in the case of the conventional Ti₃O₅ sintered powder, the initial-stage sintered powders subjected to pressure each had a crystal structure with a magnetization lower than the magnetization of a crystal structure in a paramagnetic metal state at the time when the sintered powders are cooled to 460 [K] or lower after being heated to a temperature higher than 460 [K]. Upon application of pressure, these sintered powders undergo phase transition to a crystal structure with a magnetization lower than the magnetization of a crystal structure in a paramagnetic metal state at 460 [K] or lower.

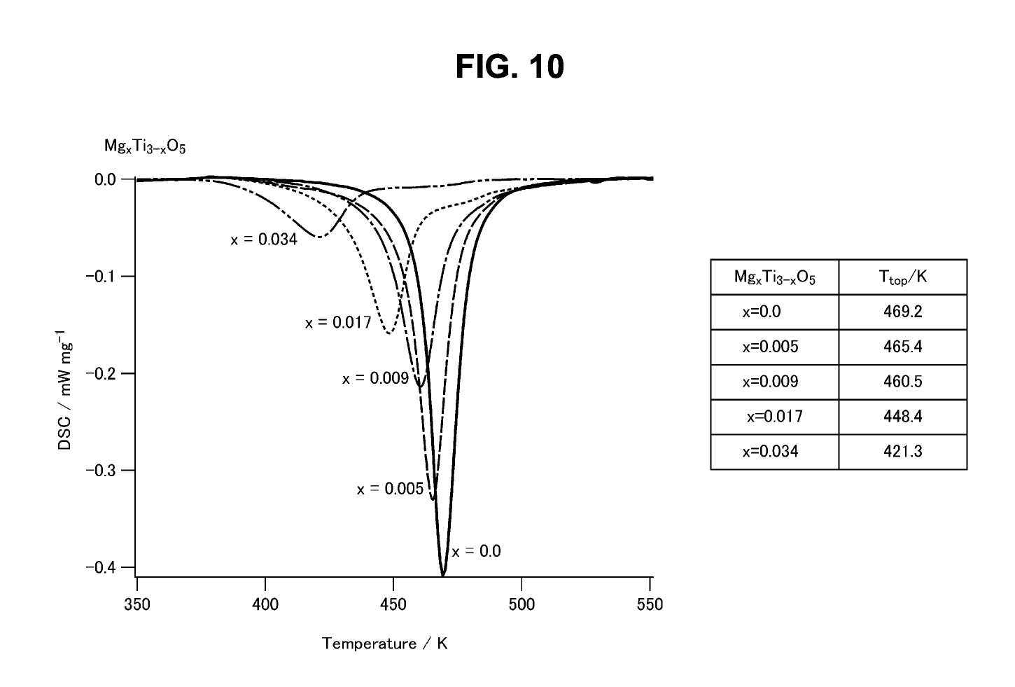

Next, for each of these sintered powders wherein x=0.005, x=0.009, x=0.017 or x=0.034 and the Ti₃O₅ sintered powder, the phase transition temperature of the crystal structure was examined by DSC while the sintered powder was heated from 350 [K] to 550 [K] after being subjected to pressure as described above, and results shown in FIG. 10 were obtained. As shown in FIG. 10, a peak was observed in each of the sintered powders as in the case of the conventional Ti₃O₅ sintered powder.

It was confirmed that the temperature of the peak top Tₜₒₚ decreased as the value of x in MgₓTi₍₃₋ₓ₎O₅ became larger. From such a change in peak top Tₜₒₚ, it was possible to confirm that in the sintered powder, the phase transition temperature of the crystal structure decreased as the value of x in MgₓTi₍₃₋ₓ₎O₅ was increased, i.e. as the content of Mg was increased.

(8) Phase Transition Temperature of Crystal Structure in Metal-Substituted Titanium Oxide of MgₓTi₍₃₋ₓ₎O₅ (x=0.015, x=0.028 and x=0.034)

Here, for the “(3) Metal-substituted titanium oxide in which some of Ti sites of Ti₃O₅ are substituted with Mn” as described above, the phase transition temperature of the crystal structure was examined by DSC while the value of x was changed to 0.015, 0.028 and 0.034. By the same production method as described above in “(3-1) Verification test”, metal-substituted titanium oxide sintered bodies composed of metal-substituted titanium oxides of MnₓTi₍₃₋ₓ₎O₅ with different values of x were produced. Sintered powders composed of the metal-substituted titanium oxide sintered bodies were prepared as samples.

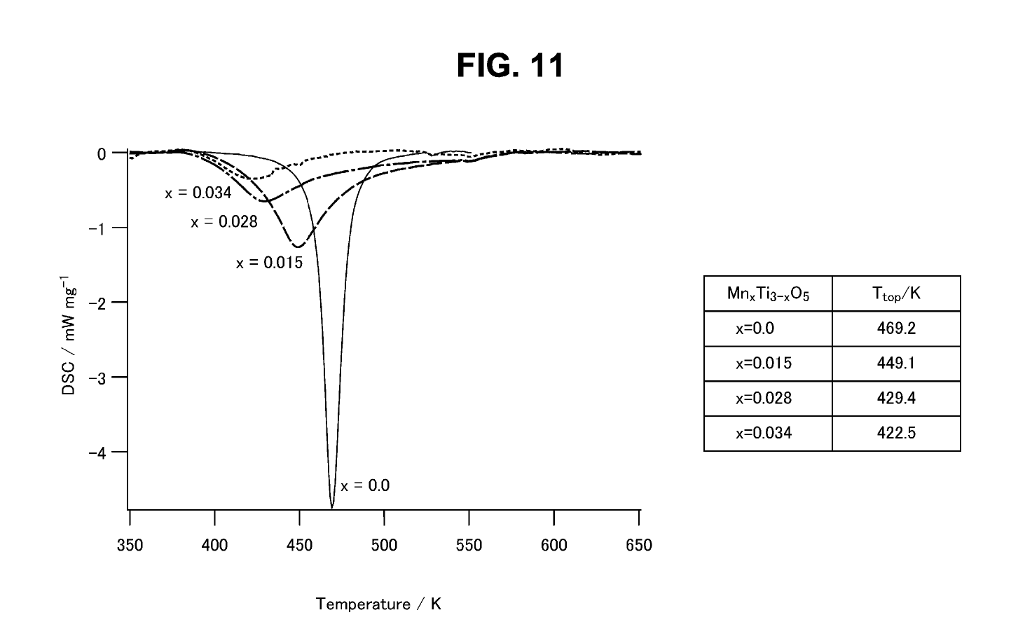

These sintered powders wherein x=0.015, x=0.028 or x=0.034 and the Ti₃O₅ sintered powder were subjected to pressure at 2 [GPa] (40 [kN], 10 [min]) to prepare samples of 5 [mmφ]. For each of the samples, the phase transition temperature of the crystal structure was examined by DSC while the sample was heated from 350 [K] to 550 to 650 [K], and results shown in FIG. 11 were obtained. As shown in FIG. 11, a peak was observed in each of the sintered powders as in the case of the conventional Ti₃O₅ sintered powder.

It was confirmed that the temperature of the peak top Tₜₒₚ decreased as the value of x in MnₓTi₍₃₋ₓ₎O₅ became larger. From such a change in peak top Tₜₒₚ, it was possible to confirm that in the sintered powder, the phase transition temperature of the crystal structure decreased as the content of Mn in MnₓTi₍₃₋ₓ₎O₅ was increased. Upon application of pressure, these sintered powders also underwent phase transition to a crystal structure with a magnetization lower than the magnetization of a crystal structure in a paramagnetic metal state at 460 [K] or lower.

(9) Phase Transition Temperature of Crystal Structure in Metal-Substituted Titanium Oxide of AlₓTi₍₃₋ₓ₎O₅ (x=0.004, x=0.007 and x=0.023)

Here, for the “(4) Metal-substituted titanium oxide in which some of Ti sites of Ti₃O₅ are substituted with Al” as described above, the phase transition temperature of the crystal structure was examined by DSC while the value of x was changed to 0.004, 0.007 and 0.023. By the same production method as described above in “(4-1) Verification test”, metal-substituted titanium oxide sintered bodies composed of metal-substituted titanium oxides of AlₓTi₍₃₋ₓ₎O₅ with different values of x were produced. Sintered powders composed of the metal-substituted titanium oxide sintered bodies were prepared as samples.

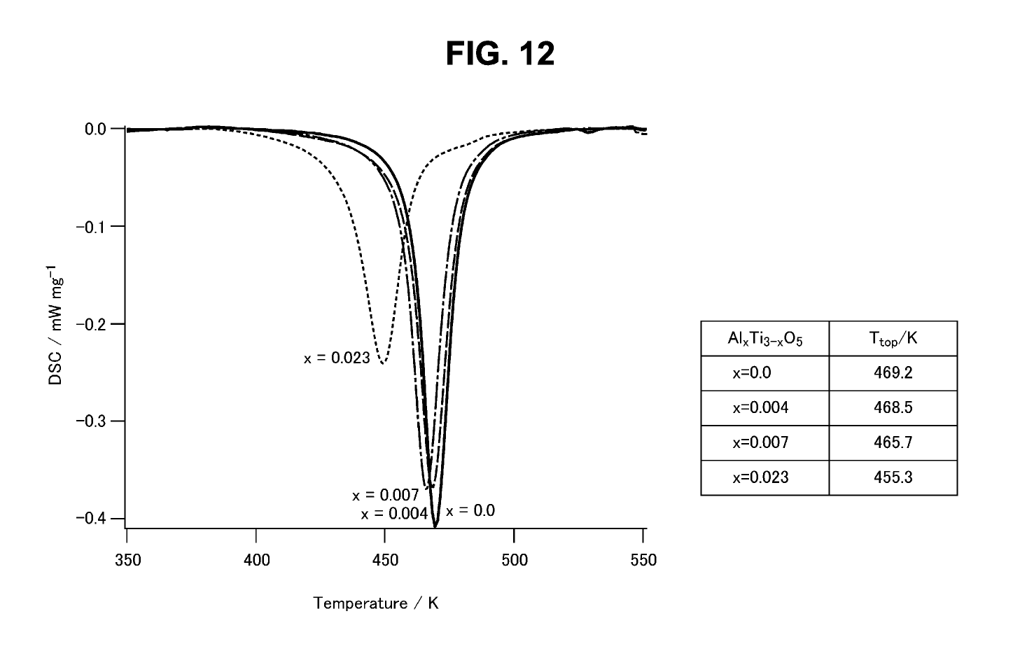

These sintered powders wherein x=0.004, x=0.007 or x=0.023 and the Ti₃O₅ sintered powder were subjected to pressure at 600 [MPa] (80 [kN], 10 [min]) to prepare samples of 13 [mmφ]. For each of these samples, the phase transition temperature of the crystal structure was examined by DSC while these sample was heated from 350 [K] to 550 [K], and results shown in FIG. 12 were obtained. As shown in FIG. 12, a peak was observed in each of the sintered powders as in the case of the conventional Ti₃O₅ sintered powder.

It was confirmed that the temperature of the peak top Tₜₒₚ decreased as the value of x in AlₓTi₍₃₋ₓ₎O₅ became larger. From such a change in peak top Tₜₒₚ, it was possible to confirm that in the sintered powder, the phase transition temperature of the crystal structure decreased as the content of Al in AlₓTi₍₃₋ₓ₎O₅ was increased. Upon application of pressure, these sintered powders also underwent phase transition to a crystal structure with a magnetization lower than the magnetization of a crystal structure in a paramagnetic metal state at 460 [K] or lower.

1. A metal-substituted titanium oxide having a composition in which some of Ti sites of Ti₃O₅ are substituted with any one of Mg, Mn, Al, V and Nb, wherein the metal-substituted titanium oxide has a crystal structure which does not undergo phase transition to a crystal structure having the properties of a nonmagnetic semiconductor even at 460 [K] or lower but maintains a paramagnetic metal state over the entire temperature range of 0 to 800 [K] and which undergoes phase transition to a crystal structure of a nonmagnetic semiconductor upon application of pressure or light.

2. The metal-substituted titanium oxide according to claim 1, having a composition of AₓTi₍₃₋ₓ₎O₅ wherein A is Mg, and x satisfies 0<x≤0.09.

3. The metal-substituted titanium oxide according to claim 1, having a composition of AₓTi₍₃₋ₓ₎O₅ wherein A is any one of Mn, V and Nb, and x satisfies 0<x≤0.18.

4. The metal-substituted titanium oxide according to claim 1, having a composition of AₓTi₍₃₋ₓ₎O₅ wherein A is Al, and x satisfies 0<x≤0.51.

5. The metal-substituted titanium oxide according to claim 1, wherein the crystal structure maintaining the paramagnetic metal state before the crystal structure is subjected to the pressure or the light does not show an X-ray diffraction peak of β-Ti₃O₅ in X-ray diffraction.

6. The metal-substituted titanium oxide according to claim 1, wherein the crystal structure which has undergone phase transition to a nonmagnetic semiconductor upon application of the pressure or the light shows the X-ray diffraction peak of β-Ti₃O₅ in X-ray diffraction.

7. The metal-substituted titanium oxide according to claim 1, wherein the crystal structure which has undergone phase transition to a nonmagnetic semiconductor upon application of the pressure or the light has a magnetization lower than a magnetization of the crystal structure in the paramagnetic metal state at 460 [K] or lower.

8. A method for producing a metal-substituted titanium oxide sintered body, the method comprising:
mixing a solution containing A (A is any one of Mg, Mn, Al, V and Nb) with a dispersion liquid in which TiO₂ particles are dispersed to generate particles composed of TiO₂ and A in the mixed solution; and
sintering a precursor powder composed of particles extracted from the mixed solution under a hydrogen atmosphere to produce a metal-substituted titanium oxide sintered body composed of a metal-substituted titanium oxide in which some of Ti sites of Ti₃O₅ are substituted with A.

9. The method for producing a metal-substituted titanium oxide sintered body according to claim 8, wherein the atomic ratio between A and Ti in the mixed solution is A:Ti=more than 0:less than 100 to 6:94 when A is any one of Mg, Mn, V and Nb.

10. The method for producing a metal-substituted titanium oxide sintered body according to claim 8, wherein the atomic ratio between A and Ti in the mixed solution is A:Ti=more than 0:less than 100 to 10:90 when A is Al.

11. The method for producing a metal-substituted titanium oxide sintered body according to claim 8, wherein the precursor powder is sintered at 900 to 1500[° C.] under a hydrogen atmosphere at 0.05 to 0.9 [L/min].
